(19) United States
(12) Patent Application Publication
(10) Pub. No.: US 2020/0047685 A1
(43) Pub. Date: Feb. 13, 2020

(54) APPARATUS AND METHOD FOR AN ILLUMINATED SUN VISOR

(71) Applicant: Troy Eide, Northbrook, IL (US)

(72) Inventor: Troy Eide, Northbrook, IL (US)

(21) Appl. No.: 16/058,317

(22) Filed: Aug. 8, 2018

(51) Int. Cl. B60R 11/02; B60J 3/02; B60R 11/00; H04W 4/48; G06F 3/14; G09F 13/22

(52) U.S. Cl. CPC B60R 11/0235; B60J 3/0204; B60R 11/00; H04W 4/48; G09F 2013/227; G09F 13/22; B60R 2011/0035; G09F 2013/222; G06F 3/14

(57) ABSTRACT

A vehicle sun visor is disclosed. The sun visor has a panel. The panel having a display portion and an energy source and is communicably coupled to a computing device. the computing device determines a message to be illuminated on the panel and sends the message to the panel by a signal. After receiving the signal at the panel, the message is displayed on the panel. The panel is hinged such that it can be displayed to external viewers.

### FIELD OF THE INVENTION

The present invention relates generally to panels on vehicle sun visors, and particularly to deliver a message on a panel on a vehicle sun visor.

### BACKGROUND

Display signs used for advertising or for displaying direction or other information to motorists have an important feature in common. They should be eye-catching and their information should be easy to absorb. This is especially true of signs to be located on the highway where the motorist may be moving fast and may need to absorb the information quickly.

Such display signs have traditionally used fluorescent or incandescent lamps which are expensive in electricity and may need frequent maintenance and repair. Each lamp usually forms an appreciable part of any letter in a display of information, and so, if any one lamp becomes non-functional it has an appreciable effect on decipherability and as more lamps become non-functional it may be considerably more difficult to decipher the letter. on the job site itself. Both solutions to the problem are unsatisfactory.

Presently, car share programs allow the user to know the driver name and vehicle type with license plate when signing up for a ride. The user is then stretching their neck to determine if the make color of the vehicle is correct and then to try to determine the license plate number. It is time consuming, people miss their rides and are charged a fee for not making it to their ride, and can be a safety hazard if the user gets in the wrong car or if the user goes into the street to read the license plate.

### BRIEF DESCRIPTION OF THE DRAWINGS

FIG. 1 is a view of a windshield of a vehicle with an exemplary panel.

FIG. 2 is a view of front of a displayed panel of FIG. 1.

FIG. 3 is a view of the front of a second displayed panel of FIG. 1.

FIG. 4 is an view of a back of a panel.

### DETAILED DESCRIPTION

Disclosed is an apparatus and method for an illuminated sun visor, which may also be referred to herein as a “ride share visor sign.” Reference will now be made in detail to the present preferred embodiments, examples of which are illustrated in the accompanying drawings. All terms in the plural shall also be taken as singular and vice-versa. Further, any reference to he shall also be applicable to she and vice-versa.

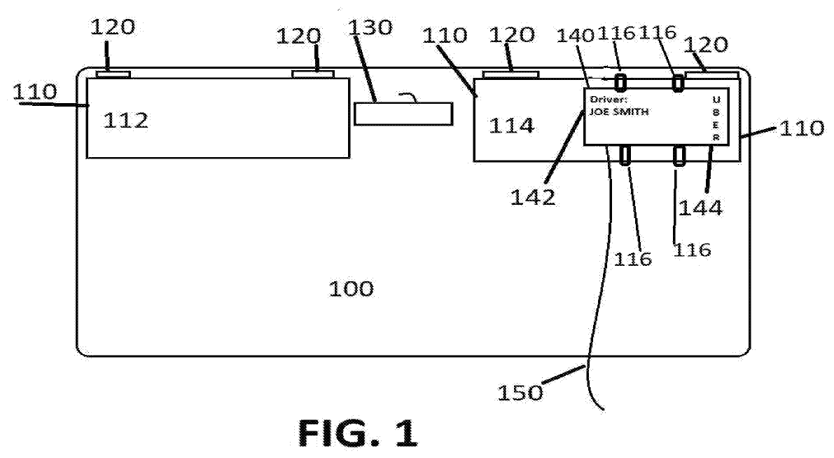

Referring now to FIG. 1, a view of a windshield 100 of a vehicle. The windshield 100 of the vehicle may be a windshield for any type or kind of vehicle, such as a car, a truck, a bus, a motorcycle, etc. The windshield 100 of the vehicle has at least one sun visor 110.

The sun-visor 110 may cover the complete width of the window slight above eye level of a driver or passenger or may have more than one sun visor 110 such that each of the passenger and the driver can manipulate the sun visor 110 separately. As shown the sun visor 110 has a driver sun visor 112 and a passenger sun visor 114 The sun-visor 110 may be movable at the hinge 120 in that the sun visor 110 may be able to be disconnected at one end and moved to be block the sun from a side window, not shown.

The windshield 100 typically has a rear-view mirror 130. The rear-view mirror 130 is typically in the middle or center portion of the windshield 100. The rear-view mirror 130 is adjustable to allow the driver to see thru the back window and observe any activity behind the vehicle.

The passenger sun visor 114 is connected to a display panel 140. The display panel 140 is coupled to the passenger sun visor 114 by clips 116, the clips 116 being closer to the passenger being rotatable left and right such that the display panel 140 may be moved to allow other views of the display panel 140. The clips 116 may be any type of clips or connectors, such as tension clips. The display panel 140 is adjustable to be moved forward towards a passenger window. The display panel 140 may have one or more lamps or other type of visible display. The panel 140 may be any panel capable of displaying information obtained from another source. The panel 140 may display messages, numbers, locations, etc. The display panel 140 illuminates, in the FIG. 1, the name of the driver 142 and a company name 144.

The display panel 140 has a connecting cable 150. The connecting cable 150 may be a USB cable, a coax cable, a LAN cable, etc. The connecting cable 150 may be useful in connecting a computing device, not shown, to the panel 140.

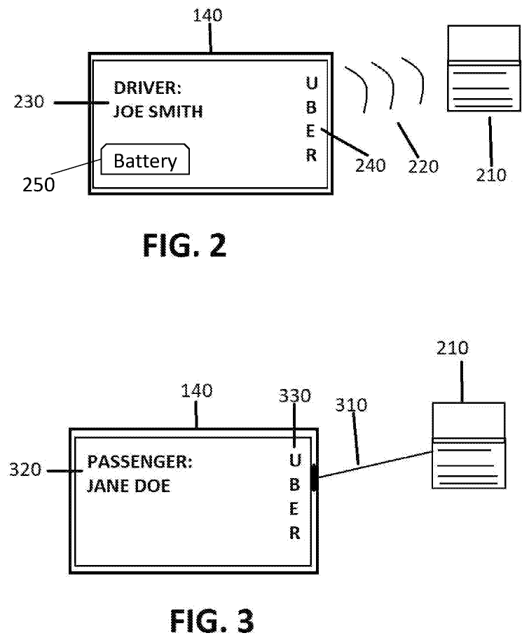

Moving now to FIG. 2, an exemplary view of the panel 140 of the windshield 100 of FIG. 1 is described. The panel 140 is communication with a computing device 210. The computing device 210 may be any device that can contain information and send signals to direct the panel 140 to illuminate a message. The panel 140 is communicably coupled to the computing device 210 by a wireless connection. This connection 220 may be any wireless connection, such as IEEE 802.11 (WiFi), IEEE 802.15 (Bluetooth), etc. The connection 220 although shown as a wireless connection could also connected via a hard-wire. The computing device 210 has a storage device, a key pad entry, a wireless receiver, a CPU. The computing device 210 is capable of being coupled via a heavy connector in close proximity to the display panel 140 or may be remote from the location of the display panel 140. The computing device 210 has the software necessary to convert the information into any language that is required by a display device 140. The computing device 210 may be connected to a wireless device where an app may be downloaded. The downloaded app may control the language and the information for display on the display panel 140. The display panel may also have a battery indicator 250. The battery indicator 250 may indicate to the driver the need to charge or replace the battery. The battery may be coupled to the passenger visor 114, windshield of the vehicle, dashboard, seat, etc.

The message displayed in this example are a driver 230 and a company 240. The information displayed on the panel 140 may include any information a driver or a company desires to show, this could include advertisements, availability of the vehicle for hire, next location the vehicle will stop at, etc.

Referring now to FIG. 3, a second view of the panel 140 of the windshield 100 of FIG. 1 is described. The panel 140 is communication with a computing device 210. The computing device 210 may be any device that can contain information and send signals to direct the panel 140 to illuminate a message. The panel 140 is communicably coupled to the computing device 210 by a hard-wired connection 310. This connection 310 may be any hard-wire connection, such as USB, HDMI, etc. The connection 310 may also be via wireless connection, such as IEEE 802.11 (WiFi), IEEE 802.15 (Bluetooth), etc.

The message displayed in this example is a customer 320 and a company 330. The information displayed on the panel 140 may include any information a driver or a company desires to show, this could include advertisements, availability of the vehicle for hire, next location the vehicle will stop at, etc.

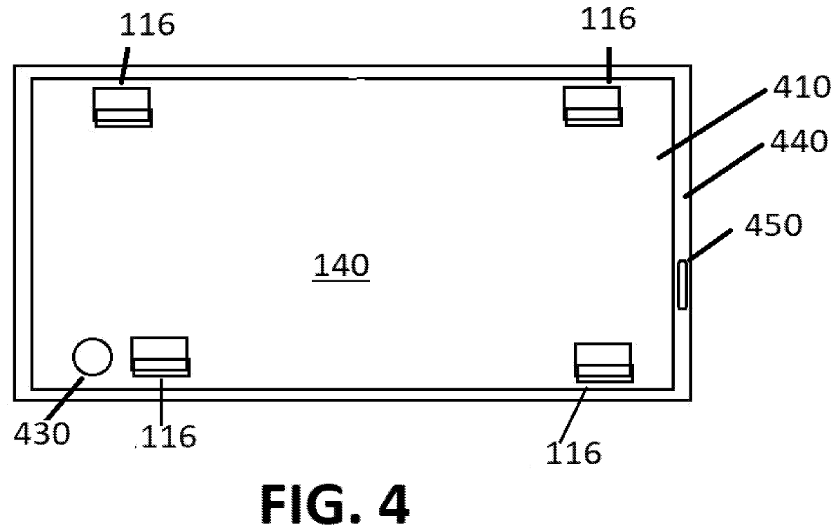

Now referring to FIG. 4, an exemplary view of a back portion 410 of the panel 140 of FIG. 1 is described. The back portion 410 of the panel 140 has at least one connector 420. The at least one connector 420 is a hinge as shown, but may also be velcro, etc. The connectors 420 are hinged in such a way as to allow the panel 140 to be connected to a sun visor 114 and still be turned to reveal the message through another port to an external viewer. The clips 116 may be adjustable and allow the display panel 140 to be moved forward and tilted to allow an easier view for others. The clips 116 may also be unengaged to allow for the display panel to swivel or turn.

The back portion 410 of the panel 140 also has a energy connector 430. The energy connector 430 is for powering the panel 140. The energy connector may be any suitable connector for a cigarette lighter in the vehicle, an external energy source, etc.

The back portion 410 of the panel 140 further has a side portion 440. The side portion 440 has a connector 450 for a source. The source can be any source for input into the panel 140 and may include a computing device, or any other device capable of sending a message to have displayed on the panel 140. The connector 450 may be a USB connector, a thunderbolt connector, a fire connector, etc.

When a message is desired to be illuminated on a panel 140. The panel receives a signals as determined by a computing device. The panel then directs the lighting of its display to simulate that which was sent by the computing device. The panel is then turned to make it easier to those outside of the vehicle to read the message.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A vehicle sun visor, the sun visor comprising:
a panel, the panel having a display portion and an energy source;
the panel being communicably coupled to a computing device;
the computing device determining a message to be illuminated on the panel and sending the message to the panel by a signal;
receiving the signal at the panel, and
lighting the lamps based on the message received.

2. The vehicle sun visor of claim 1, wherein the panel further comprises a USB port.

3. The vehicle sun visor of claim 1, wherein the panel is coupled to the cigarette outlet for power.

4. The vehicle sun visor of claim 1, wherein the panel displays a driver's name.

5. The vehicle sun visor of claim 1, wherein the panel displays a rider's name.

6. The vehicle sun visor of claim 1, herein the panel is mounted to the vehicle sun visor by clips.

7. The vehicle sun visor of claim 1, herein the panel is mounted to the vehicle sun visor by Velcro.

8. The vehicle sun visor of claim 1, herein the lamps are light emitting diodes (LEDs).

9. The vehicle sun visor of claim 1, herein the panel is communicably coupled to the computing device by wireless connection.

10. The vehicle sun visor of claim 9, wherein the wireless connection is WiFi.

11. The vehicle sun visor of claim 1, wherein the panel further comprises an internal battery.

12. A method for displaying information on a vehicle sun visor, comprising the steps of:
hingedly attaching a panel onto the vehicle sun visor;
connecting the panel to a computing device;
receiving a signal indicating a message from the computing device;
directing the lighting of one or more lamps to illuminate to form the message; and
moving the panel such that the message is viewable outside of the vehicle.

13. The method of claim 12 wherein the lamps are light emitting diodes.

14. The method of claim 12 wherein the panel is coupled to an energy source.

15. The method of claim 12 wherein the panel is hingedly attached to the vehicle sun visor by clips.
